(19) United States
(12) Patent Application Publication
(10) Pub. No.: US 2018/0075313 A1
(43) Pub. Date: Mar. 15, 2018

(54) DATA GENERATION DEVICE AND IMAGE PROCESSING SYSTEM AND METHOD

(71) Applicant: Renesas Electronics Corporation, Tokyo (JP)

(72) Inventor: Yayumi UEHARA, Tokyo (JP)

(21) Appl. No.: 15/626,144

(22) Filed: Jun. 18, 2017

(30) Foreign Application Priority Data
Sep. 9, 2016 (JP) 2016-176719

(51) Int. Cl. G06K 9/32; G06K 9/00

(52) U.S. Cl. CPC G06K 9/3241; G06T 2207/10021; G06K 9/00295; G06K 9/00778

(57) ABSTRACT

A data generation device is configured to be able to communicate with an external device performing an image process. The data generation device includes a data generation unit that generates a data unit including image data received from a camera via a first communication interface and sensor data received from a sensor via a second communication interface and transmits the same to the external device. The external device is configured to determine the content of the image process for the image data associated with the sensor data on the basis of the sensor data included in the data unit. The data generation unit generates the data unit including the image data and the sensor data output from the sensor on the basis of information for synchronization received from the camera via the first communication interface.

### CROSS-REFERENCE TO RELATED APPLICATIONS

The disclosure of Japanese Patent Application No. 2016-176719 filed on Sep. 9, 2016 including the specification, drawings and abstract is incorporated herein by reference in its entirety.

### BACKGROUND

The disclosure relates to a technique for generating a data unit, and more particularly, to a technique for generating a data unit including image data and sensor data.

For the purpose of effectively using information included in an image, various image processes such as deformation and conversion of the image and extraction of characteristics have been performed from the past (for example, “Image Processing, Wikipedia, [online], [searched on Jul. 7, 2016], Internet <URL:https://ja.wikipedia.org/wiki/%E7%94%BB%E5%83%8F%E5%87%A6%E7%90%86>”).

Further, for the purpose of quality inspection of industrial products, “Image inspection software by SKYLOGIQ, EasyInspector, [online], [searched on Jul. 7, 2016], Internet <URL:http://www.skylogiq.co.jp/easyinspector/kensa_gaiyou/index.html>” discloses a configuration in which dimension inspection of products by processing an image and inspection such as detection of minute stains are performed.

Further, “In-vehicle camera application: image recognition car navigation system & In-vehicle partner robot by Naohiko Ichihara and the other three, [online], [searched on Jul. 7, 2016], Internet <URL:http://pioneer.jp/en/crdl_design/crdl/rd/pdf/19-1-1.pdf>” discloses a configuration in which a real-time image process is performed for an image photographed by an on-vehicle camera, and a sign and a traffic light included in the image are highlighted to arouse attention of a user.

### SUMMARY

With the advanced microfabrication (namely, increased number of pixels) of an imaging element of a camera in recent years, there have been problems such as an increase in processing time due to an increase in the load of an image process and an increase in power consumption by a processor.

The technique disclosed in “In-vehicle camera application: image recognition car navigation system & In-vehicle partner robot by Naohiko Ichihara and the other three, [online], [searched on Jul. 7, 2016], Internet <URL:http://pioneer.jp/en/crdl_design/crdl/rd/pdf/19-1-1.pdf>” is configured to perform a predetermined image processing program for all images photographed by a camera. More specifically, the technique is configured in such a manner that whether or not a sign and a traffic light are included in the photographed image is determined by an image process, and then an image process of highlighting these objects is performed. Namely, a certain image process needs to be performed even for an image including no object to be highlighted in the technique, and thus the load of the image process is increased.

Further, reduction in the load of the image process is not referred to in each of the techniques disclosed in “Image Processing, Wikipedia, [online], [searched on Jul. 7, 2016], Internet <URL:https://ja.wikipedia.org/wiki/%E7%94%BB%E5%83%8F%E5%87%A6%E7%90%86>” and “Image inspection software by SKYLOGIQ, EasyInspector, [online], [searched on Jul. 7, 2016], Internet <URL:http://www.skylogiq.co.jp/easyinspector/kensa_gaiyou/index.html>”. Therefore, a technique to further reduce the load of the image process has been required.

The disclosure has been achieved to solve the above-described problems, and an object thereof in a certain aspect is to provide a data generation device for generating data by which the load of an image process can be reduced. An object thereof in another aspect is to provide an image processing system by which the load of an image process can be reduced. An object thereof in still another aspect is to provide a method by which the load of an image process can be reduced.

The other objects and novel features will become apparent from the description of the specification and the accompanying drawings.

A data generation device according to an embodiment is configured to be able to communicate with an external device pertaining an image process. The data generation device includes: a first communication interface that receives image data obtained by a camera; a second communication interface that receives sensor data output from a sensor; and a data generation unit that generates a data unit including the image data received via the first communication interface and the sensor data received via the second communication interface and transmits the generated data unit to the external device. The external device is configured to determine the content of the image process for the image data associated with the sensor data on the basis of the sensor data included in the data unit. The data generation unit generates the data unit including the image data and the sensor data output from the sensor on the basis of information for synchronization received from the camera via the first communication interface.

A data generation device according to an embodiment can generate data by which the load of an image process can be reduced.

The above and other objects, features, aspects, and advantages of the invention will become apparent from the following detailed description related to the invention that can be understood in association with the accompanying drawings.

### BRIEF DESCRIPTION OF THE DRAWINGS

FIG. 1 is a flowchart for explaining the control of an image process according to a related technique;

FIG. 2 is a diagram for explaining a configuration example of an image processing system 200 according to an embodiment;

FIG. 3 is a diagram for explaining a hardware configuration example of each device configuring the image processing system 200 according to an embodiment;

FIG. 4 is a diagram for explaining a structure of packet data 400 compliant with DisplayPort;

FIG. 5 is a flowchart for explaining the control of an image process according to an embodiment;

FIG. 6 is a flowchart for explaining a method of generating a data unit according to an embodiment;

FIG. 7 is a flowchart for explaining a method of generating the data unit according to another aspect;

FIG. 8 is a flowchart for explaining the control of quality inspection according to the related technique;

FIG. 9 is a diagram for explaining a configuration example of an image processing system 900 according to an embodiment;

FIG. 10 is a flowchart for explaining the control of quality inspection (image process) according to an embodiment;

FIG. 11 is a flowchart for explaining an image process for monitoring according to the related technique;

FIG. 12 is a diagram for explaining a configuration example of an image processing system 1200 according to an embodiment;

FIG. 13 is a flowchart for explaining the control of an image process according to an embodiment;

FIG. 14 is a diagram for explaining a configuration example of an image processing system 1400 according to an embodiment; and

FIG. 15 is a flowchart for explaining a method of generating a data unit according to an embodiment.

### DETAILED DESCRIPTION

Hereinafter, embodiments of the present invention will be described in detail with reference to the drawings. In the following description, the same components are followed by the same signs. These names and functions are also the same. Thus, the detailed explanation thereof will not be repeated.

### First Embodiment

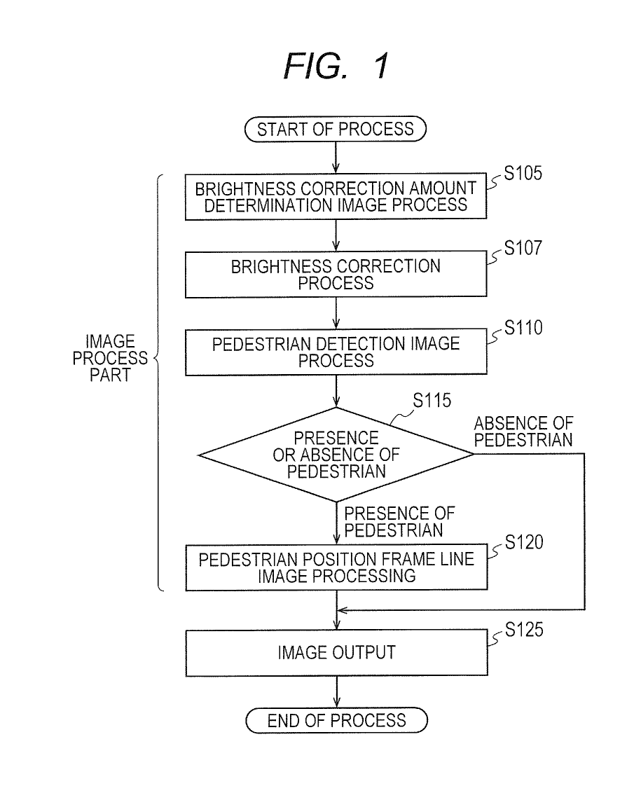

FIG. 1 is a flowchart for explaining the control of an image process according to the related technique. In the example shown in FIG. 1, a processor reads an image processing program according to the related technique to detect a pedestrian on the basis of image data obtained by an on-vehicle camera, and highlights the pedestrian.

In Step S105, the processor determines a brightness correction amount on the basis of the image data obtained by the camera. As an example, the processor reads the image data, and determines the correction amount of the Υ characteristic for each pixel.

In Step S107, the processor corrects the image data on the basis of the determined brightness correction amount.

In Step S110, the processor executes a pedestrian detection process on the basis of the image data. As an example, the processor extracts a characteristic amount related to a human such as detecting a skin color area in the image data.

In Step S115, the processor determines whether or not a pedestrian (human) exists in the image photographed by the camera on the basis of the result of Step S110. In the case where the processor determines that a pedestrian exists in the image (presence of pedestrian in Step S115), the process proceeds to Step S120. Otherwise (absence of pedestrian in Step S115), the processor advances the process to Step S125.

In Step S120, the processor processes the image data in such a manner that the pedestrian is surrounded using a frame line, so that the pedestrian in the image is highlighted.

In Step S125, the processor outputs the image data to a display provided in the car. Accordingly, the driver recognizes that there is a pedestrian at the rear of the car.

As described above, the image processing program according to the related technique allows the processor to execute the image process (Steps S105 and S107) of the brightness correction and the image process (Steps S110 and S115) of the pedestrian detection even for an image in which no pedestrian exists. Therefore, the load on the processor for the image processing program according to the related technique is increased. Hereinafter, an image processing system according to an embodiment that can solve the problem will be described.

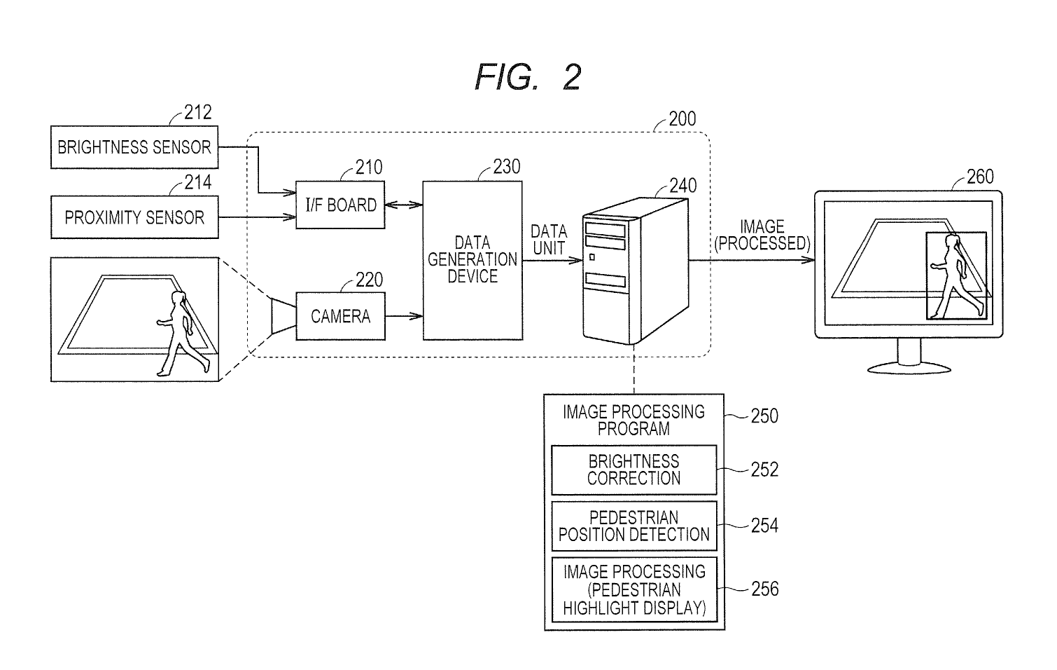

FIG. 2 is a diagram for explaining a configuration example of an image processing system 200 according to an embodiment. With reference to FIG. 2, the image processing system 200 includes an I/F (interface) board 210, a camera 220, a data generation device 230, and an information processing terminal 240. In a certain aspect, the image processing system 200 is mounted in a car.

The I/F board 210 is an interface for coupling an external sensor and the data generation device 230 to each other. In a certain aspect, the I/F board 210 is compliant with the standards of a USB (Universal Serial Bus), IEEE (Institute of Electrical and Electronic Engineers) 1394, and/or RS-232C. In the example of FIG. 1, the I/F board 210 is electrically coupled to each of a brightness sensor 212, a proximity sensor 214, and the data generation device 230.

The brightness sensor 212 detects brightness outside the car. As an example, the brightness sensor 212 is configured using a photodiode. The proximity sensor 214 detects, for example, an object that is arranged at the rear of the car and comes close to the back of the car. As an example, the proximity sensor 214 is configured using a pyroelectric element. The I/F board 210 outputs data output from the brightness sensor 212 and data output from the proximity sensor 214 to the data generation device 230.

The camera 220 is arranged at the rear of the car, and photographs around a rear part of the car. The camera 220 transmits the photographed image data to the data generation device 230.

The data generation device 230 generates a data unit including the sensor data received from the I/F board 210 and the image data received from the camera 220, and transmits the generated data unit to the information processing terminal 240. The data unit is a set of data handled as one reception unit. In a certain aspect, the data unit may be a packet. The detail of a method of generating the data unit will be described later.

The information processing terminal 240 performs an image process on the basis of the received data unit. Specifically, the information processing terminal 240 performs various image processes by executing the image processing program 250. As an example of the various image processes, a brightness correction process 252, a pedestrian position detection process 254, and/or an image processing process 256 can be included. The brightness correction process 252 includes, as an example, a process of determining the correction amount of the Υ characteristic for each pixel. The pedestrian position detection process 254 includes, as an example, a process of detecting the position of a pedestrian by extracting a characteristic amount related to a human such as detecting a skin color area in the image data. The image processing process 256 includes a process of highlighting so as to surround around the pedestrian detected by the pedestrian position detection process 254. The information processing terminal 240 outputs the image data processed in the image processing process 256 to a display 260. The information processing terminal 240 determines the content of the image process performed for the image data included in the data unit on the basis of the sensor data included in the data unit. The detail of the control will be described later.

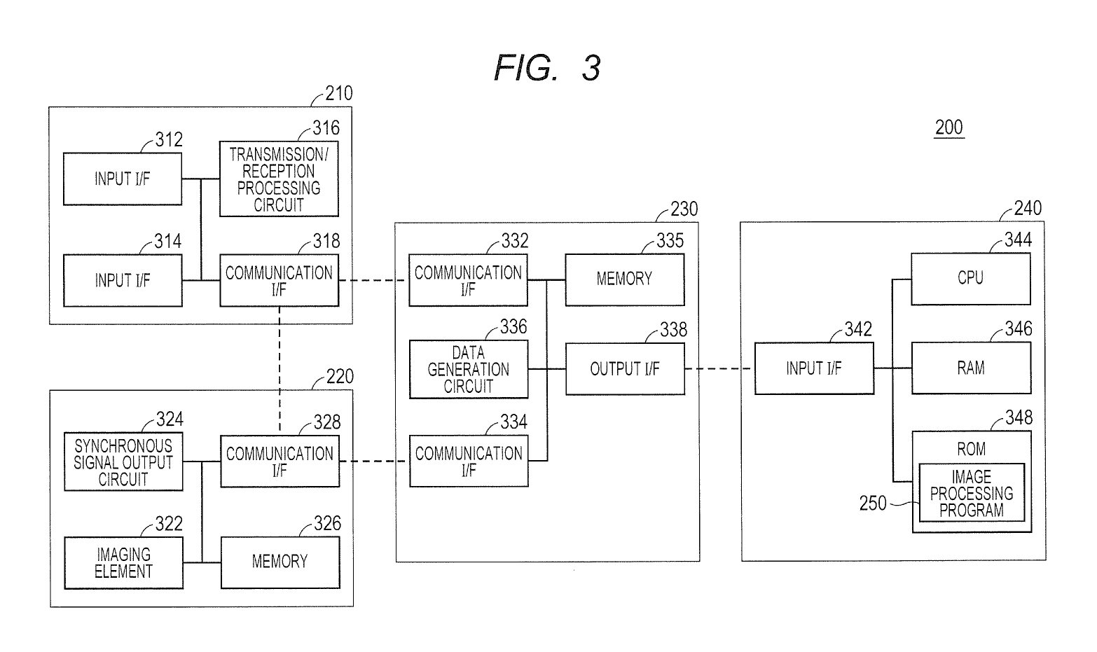

FIG. 3 is a diagram for explaining a hardware configuration example of each device configuring the image processing system 200 according to the embodiment.

The I/F board 210 includes input I/Fs 312 and 314, a transmission/reception processing circuit 316, and a communication I/F 318. The input I/F 312 is electrically coupled to the brightness sensor 212, and accepts an input of sensor data related to brightness outside the car from the brightness sensor 212. The input I/F 314 is electrically coupled to the proximity sensor 214, and accepts an input of sensor data related to an object that comes close to the rear of the car.

The I/Fs 312 and 314 output the input data to the transmission/reception processing circuit 316. In response to a synchronous signal output by a synchronous signal output circuit 324 to be described later, the transmission/reception processing circuit 316 outputs the sensor data input via the I/Fs 312 and 314 to the data generation device 230 via the communication I/F 318.

The camera 220 includes an imaging element 322, a synchronous signal output circuit 324, a memory 326, and a communication I/F 328. The imaging element 322 outputs to the memory 326 the image data obtained by converting light collected by a lens (not shown) into an electric signal. In a certain aspect, the imaging element 322 is configured using a CCD (Charge Coupled Device) sensor or a CMOS (Complementary Metal Oxide Semiconductor).

The synchronous signal output circuit 324 outputs a synchronous signal (for example, a vertical synchronous signal) to the I/F board 210 and the data generation device 230 via the communication I/F 328 every time imaging is performed by the imaging element 322. The memory 326 functions as a buffer memory that temporarily stores the image data.

The data generation device 230 includes communication I/Fs 332 and 334, a memory 335, a data generation circuit 336, and an output I/F 338.

The communication I/F 332 receives from the I/F board 210 the sensor data obtained by the brightness sensor 212 and the proximity sensor 214. The communication I/F 334 receives the image data obtained by the camera 220. The memory 335 temporarily stores the sensor data and the image data received from the I/F board 210 and the camera 220, respectively. In a certain aspect, each of the memory 326 and the memory 335 is a volatile memory, and is configured using an SRAM (Static Random Access Memory) or a DRAM (Dynamic Random Access Memory).

The data generation circuit 336 generates the data unit including the image data and the sensor data stored in the memory 335. As an example, the data generation circuit 336 according to a certain aspect generates packet data compliant with DisplayPort. The data generation circuit 336 outputs the generated packet data to the information processing terminal 240 via the output I/F 338. In a certain aspect, the data generation circuit 336 can encrypt the generated packet data in accordance with a predetermined protocol (for example, HDCP: High-bandwidth Digital Content Protection system). In a certain aspect, the output I/F 338 can be configured using a connector compliant with DisplayPort. In a certain aspect, the data generation circuit 336 is configured using, at least, one ASIC (Application Specific Integrated Circuit) designed to realize functions of circuits to be described later. In a certain aspect, the data generation circuit 336 can be configured using a circuit including a semiconductor integrated circuit such as, at least, one processor, at least, one DSP (Digital Signal Processor), at least, one FPGA (Field Programmable Gate Array), and/or a circuit having other operation functions.

The information processing terminal 240 includes an input I/F 342, a CPU (Central Processing Unit) 344, a RAM (Random Access Memory) 346, and a ROM (Read Only Memory) 348.

The input I/F 342 accepts an input of the data unit from the data generation device 230. The input I/F 342 outputs the accepted data unit to the CPU 344.

The CPU 344 executes the image processing program 250 stored in the ROM 348 to perform various image processes for the image data included in the data unit. The RAM 346 is typically configured using a DRAM, and functions as a working memory for temporarily storing data or the like necessary for the CPU 344 to execute the image processing program 250. The ROM 348 is typically configured using a flash memory, and stores various kinds of setting information used for the operations of the image processing program 250 and the information processing terminal 240. Next, as an example of the data unit, the data structure of the packet data compliant with DisplayPort will be described.

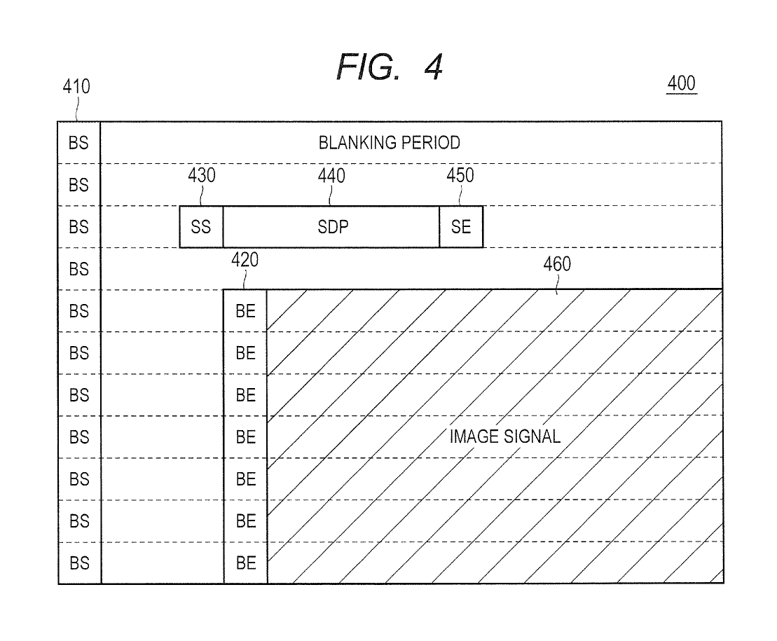

FIG. 4 is a diagram for explaining a structure of packet data 400 compliant with DisplayPort. A blanking start (BS) packet 410 is included in the beginning of a horizontal blanking period included in each line. Further, a blanking end (BE) packet 420 is included at the end of the horizontal blanking period where an image signal 460 is present. The lengths of the horizontal blanking periods are different between the line in a vertical blanking period where the image signal 460 is not present and the line where the image signal 460 is present. The BE packet 420 is followed by data of pixels configuring one line.

The packet data 400 includes a secondary data packet (SDP) 440 in the line in the vertical blanking period where the image signal 460 is not present. A secondary data start (SS) packet 430 and a secondary data end (SE) packet 450 are present before and after the SDP 440, respectively.

The SDP 440 includes additional information other than the image signal, and generally includes audio data and the like. The data generation circuit 336 according to a certain aspect generates the packet data 400 including the image data obtained from the camera 220 and the sensor data obtained from the I/F board 210. More specifically, the data generation circuit 336 generates the packet data 400, so that the image data and the sensor data are stored in the image signal 460 and the SDP 440, respectively.

As described above, the data generation circuit 336 generates the packet data 400 including the image data and the sensor data using the SDP 440 compliant with the existing DisplayPort in a certain aspect. Accordingly, the input I/F 342 of the information processing terminal 240 can also adopt a connector compliant with the existing DisplayPort.

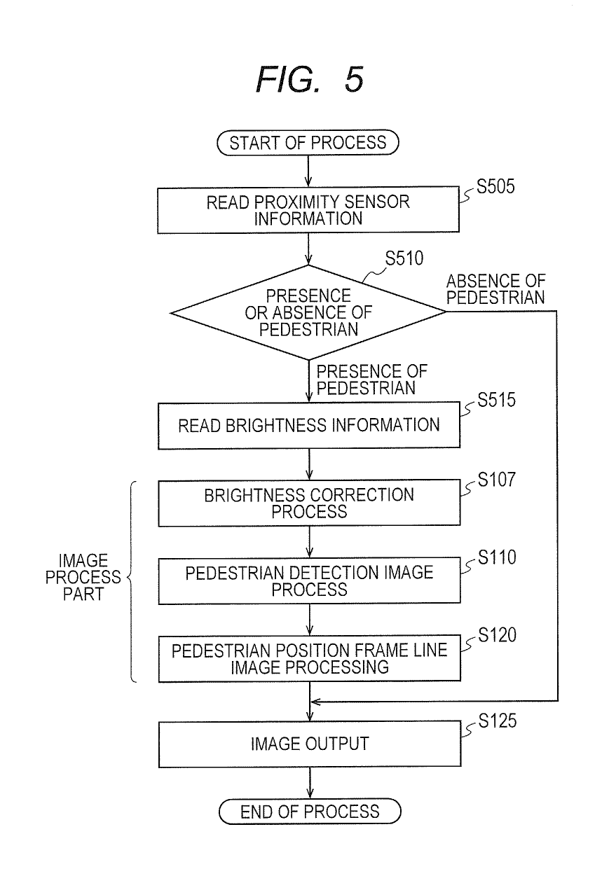

FIG. 5 is a flowchart for explaining the control of the image process according to the embodiment. The image processing program according to the related technique described in FIG. 1 performs the image process on the basis of only the image data. On the other hand, the image processing program shown in FIG. 5 is executed using the data unit including the image data and the sensor data. In the example shown in FIG. 5, the image processing program performs the image process using the packet data 400 as the data unit. The process shown in FIG. 5 is realized by the CPU 344 executing the image processing program 250 stored in the ROM 348. It should be noted that the parts followed by the same signs as those in FIG. 1 are substantially the same processes, and thus the explanation thereof will not be repeated in some cases.

In Step S505, the CPU 344 reads the sensor data (hereinafter, also referred to as “proximity data”) that is included in the SDP 440 of the packet data 400 and is obtained by the proximity sensor 214.

In Step S510, the CPU 344 determines whether or not a pedestrian (human) exists at the rear of the car on the basis of the proximity data. In the case where the CPU 344 determines that a pedestrian exists at the rear of the car (presence of pedestrian in Step S510), the process proceeds to Step 515. Otherwise (absence of pedestrian in Step S510), the CPU 344 advances the process to Step S125, and outputs the image data included in the image signal 460 of the packet data 400 to the display 260 as it is. It should be noted that the CPU 344 can output data obtained by performing brightness correction for the image data to the display 260 in another aspect.

In Step S515, the CPU 344 reads the sensor data (hereinafter, also referred to as “brightness data”) that is included in the SDP 440 and is obtained by the brightness sensor 212. In Step S107, the CPU 344 executes the brightness correction process 252 on the basis of the brightness data. As an example, the CPU 344 corrects the y characteristic for each pixel on the basis of the brightness data.

According to the above description, the image processing program 250 executes the following image process (brightness correction and highlight of a pedestrian) only when it is determined that a pedestrian comes close to the rear of the car on the basis of the proximity data included in the SDP 440. Therefore, the image processing program 250 can reduce the load on the image process of the CPU 344.

Further, the image processing program 250 can perform the brightness correction process for the image data on the basis of the brightness data included in the SDP 440 even in the case where it is determined that a pedestrian comes close to the rear of the car. Thus, the image processing program 250 can further reduce the load on the image process of the CPU 344.

The image processing program 250 can execute a series of processes shown in FIG. 5 by receiving the data unit including the image data and the sensor data synchronized with the timing of photographing the image data. Next, a method of generating the data unit by the data generation device 230 will be described.

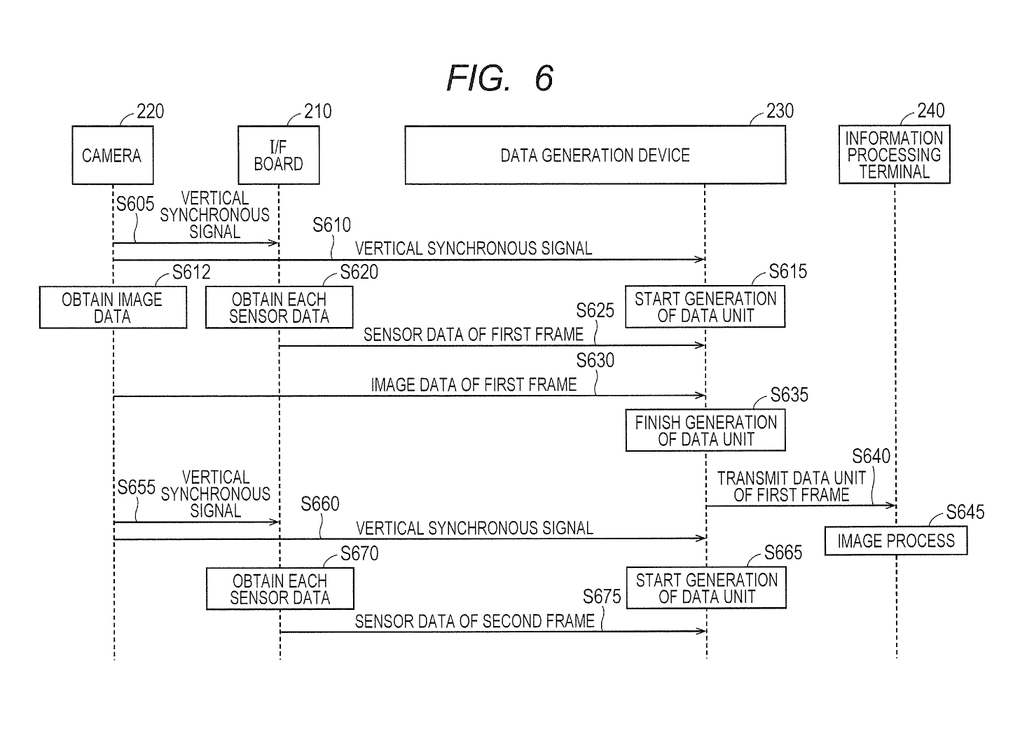

FIG. 6 is a flowchart for explaining a method of generating the data unit according to the embodiment.

In Steps S605 and S610, the camera 220 outputs the vertical synchronous signal from the synchronous signal output circuit 324 to each of the I/F board 210 and the data generation device 230. In Step S612, the camera 220 obtains the image data of the first frame by photographing. The image data is temporarily stored in the memory 326.

In Step S615, the data generation circuit 336 of the data generation device 230 starts generation of the data unit in response to the reception of the vertical synchronous signal.

In Step S620, the transmission/reception processing circuit 316 of the I/F board 210 obtains the brightness data of the first frame and the proximity data from the brightness sensor 212 and the proximity sensor 214 via the I/Fs 312 and 214, respectively, in response to the reception of the vertical synchronous signal.

In Step S625, the transmission/reception processing circuit 316 outputs the obtained brightness data and proximity data to the data generation device 230. The data generation circuit 336 temporarily stores the received sensor data of the first frame into the memory 335.

In Step S630, the data generation circuit 336 accesses the memory 326 of the camera 220 via the communication I/Fs 334 and 328 to obtain the image data of the first frame. The data generation circuit 336 temporarily stores the image data into the memory 335.

In Step S635, the data generation circuit 336 generates the data unit including the image data of the first frame stored in the memory 335 and the sensor data, and finishes the process of generating the data unit.

In Step S640, the data generation circuit 336 outputs the generated data unit to the information processing terminal 240 via the output I/F 338.

In Step S645, the CPU 344 of the information processing terminal 240 executes the series of image processes shown in FIG. 5.

The image processing system 200 repeatedly executes the processes of Steps S605 to S645 for the second and subsequent frames.

According to the above description, the data generation circuit 336 can generate the data unit by associating the image data with the sensor data output from each sensor on the basis of the vertical synchronous signal output from the camera 220. Accordingly, the data generation circuit 336 can generate the data unit by associating the image data with the sensor data obtained in synchronization with the photographing timing of the image data. As a result, the image processing program 250 using the data unit can reduce the load on the image process of the CPU 344 as compared to the conventional case.

It should be noted that the camera 220 is configured to output the vertical synchronous signal to the I/F board 210 and the data generation device 230 in the above-described example. However, the camera 220 may be configured to output the same to only the data generation circuit 336 in another aspect.

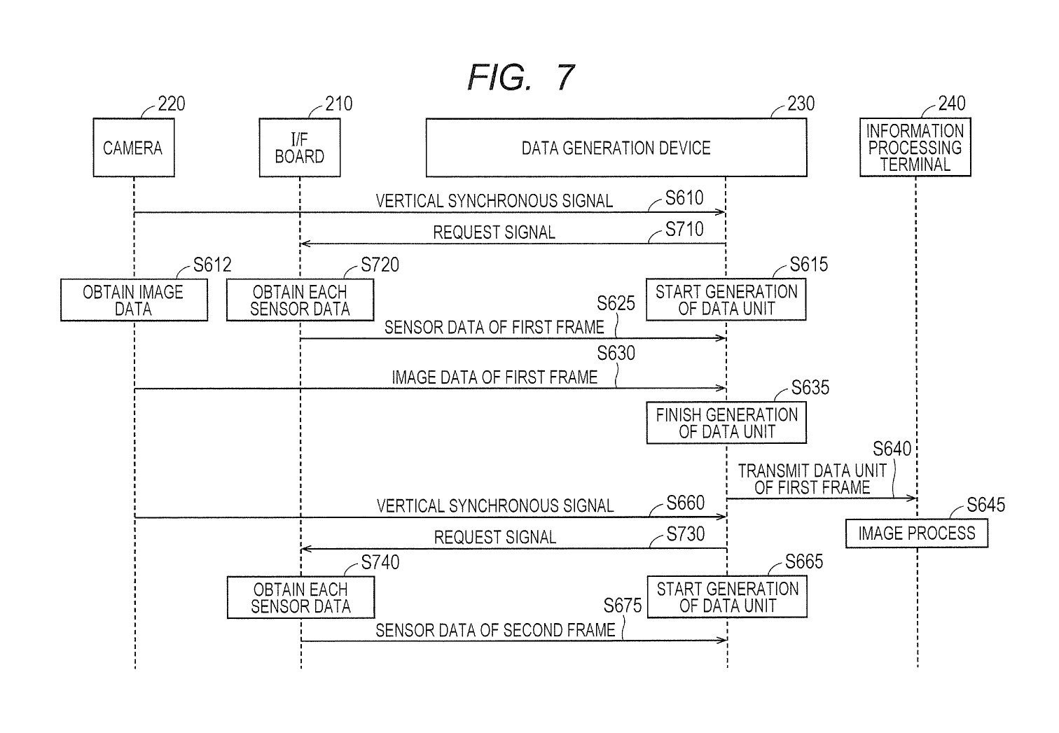

FIG. 7 is a flowchart for explaining a method of generating the data unit according to another aspect. It should be noted that the parts followed by the same signs as those in FIG. 6 are the same processes, and thus the explanation thereof will not be repeated.

In Step S710, in response to the reception of the vertical synchronous signal from the camera 220, the data generation circuit 336 outputs a request signal for requesting the I/F board 210 to output the sensor data.

In Step S720, in response to the reception of the request signal from the data generation device 230, the transmission/reception processing circuit 316 of the I/F board 210 obtains the brightness data of the first frame and the proximity data from the brightness sensor 212 and the proximity sensor 214, respectively.

According to the above description, even in the case where the I/F board 210 cannot be coupled to the camera 220 (for example, in the case where the number of interfaces provided in the I/F board 210 is insufficient), the data generation device 230 can generates the data unit.

### Second Embodiment

In the above-described embodiment, the image process for the image photographed by the on-vehicle camera 220 has been described as an example. In a second embodiment, an image process related to the quality inspection of products in a factory or the like will be described as an example.

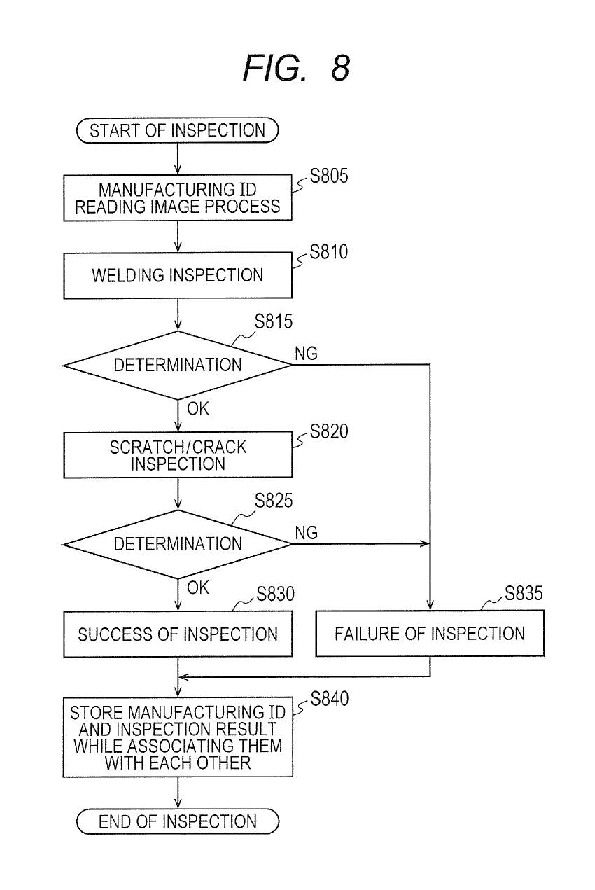

FIG. 8 is a flowchart for explaining the control of quality inspection according to the related technique. The process shown in FIG. 8 is realized by the processor executing the image processing program according to the related technique. In the example shown in FIG. 8, the image processing program according to the related technique performs quality inspection on the basis of image data showing each of a plurality of products flowing on a belt conveyor.

In Step S805, the processor recognizes a bar code on the basis of the image data of the product obtained by the camera, and specifies the manufacturing ID included in the bar code.

In Step S810, the processor executes a welding inspection process on the basis of the image data. More specifically, the processor determines whether or not a welding defect has occurred at the welded part of the product. As an example, the processor performs a process of detecting the area of a brass-colored part at the welded part. When a welding defect occurs, the welding resistance is increased due to the adhesion of an oxide to a welding electrode, and as a result, the welded part becomes a brass color.

In Step S815, the processor determines whether or not a welding defect has occurred. As an example, in the case where the area of the brass-colored part in the welded part is smaller than a predetermined area, the processor determines that a welding defect has not occurred. In the case where the processor determines that a welding defect has not occurred (OK in Step S815), the process proceeds to Step S820. Otherwise (NG in Step S815), the processor determines that the product to be inspected is a defective product. (Step S835).

In Step S820, the processor executes a scratch/crack inspection process on the basis of the image data. As an example, the processor extracts, as scratches and cracks, a pixel that largely differs in luminance from surrounding pixels.

In Step S825, the processor determines whether or not the product has scratches and cracks on the basis of the inspection result of Step S820. In the case where the processor determines that the product has neither scratches nor cracks (OK in Step S825), it is determined that the product to be inspected is a non-defective product (Step S830). Otherwise (NG in Step S825), the processor determines that the product to be inspected is a defective product (Step S835).

In Step S840, the processor associates the manufacturing ID specified in Step S805 with the inspection result to be stored in a storage device.

As described above, the inspection needs to be executed for all of plural inspection items required for the product using the image process in the quality inspection according to the related technique. Therefore, as the number of inspection items increases, the load on the quality inspection (image process) of the processor increases. In the example of FIG. 8, two inspection items have been described for the sake of simplicity. However, there may be dozens of inspection items in practice. Hereinafter, the configuration and control of the image processing system according to the embodiment that can solve such a problem will be described.

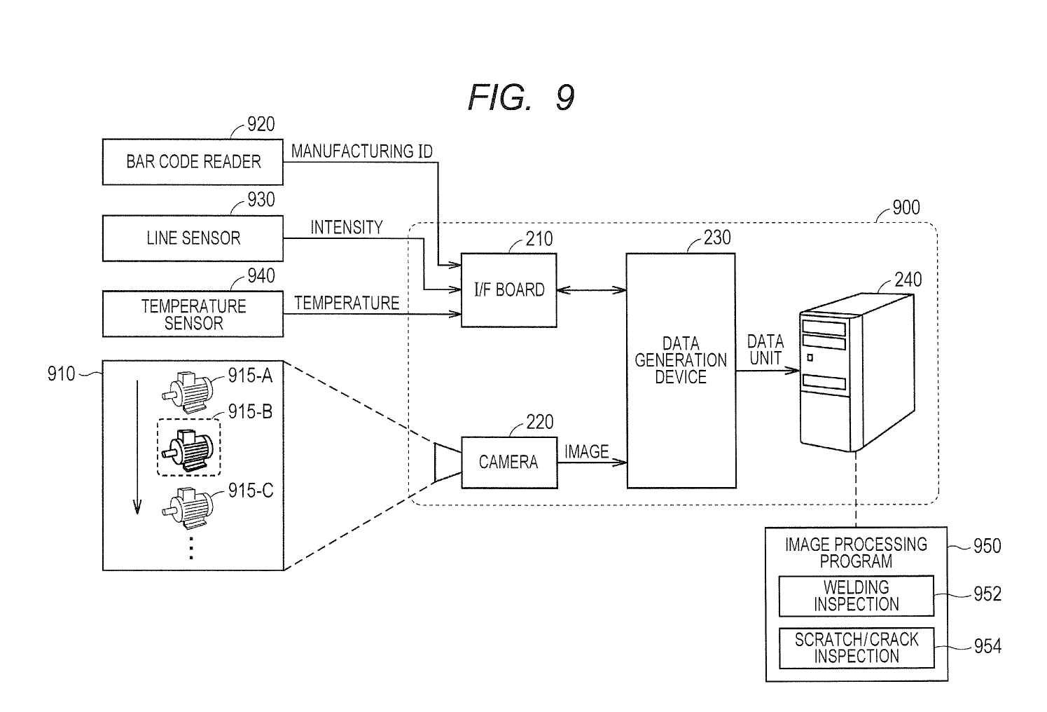

FIG. 9 is a diagram for explaining a configuration example of an image processing system 900 according to the embodiment. The configuration of the imaging processing system 900 is substantially the same as that of the above-described image processing system 200, and thus only the differences will be described.

The image processing system 900 performs quality inspection for products 915A, 915B, 915C, and the like flowing on a manufacturing line 910. Hereinafter, the products 915A, 915B, 915C, and the like will be collectively referred to as “products 915”. Bar codes indicating manufacturing IDs that can be identified from each other are attached to the products 915.

The I/F board 210 is electrically coupled to each of a bar code reader 920, a line sensor 930, and a temperature sensor 940. The bar code reader 920 obtains the manufacturing ID from the bar code attached to each product 915. The line sensor 930 includes a plurality of light projecting units and light receiving units (photodiodes). The line sensor 930 is provided in a path where the products 915 flow, and light reflected by the products 915 is accepted by the light receiving units. As an example, the temperature sensor 940 is a radiation thermometer, and measures the temperatures of the welded parts of the products 915 in a contactless manner.

The camera 220 is provided in a path where the products 915 flow, and photographs each product 915. The data generation device 230 generates the data unit including the image data of the product 915 obtained by the camera 220 and the sensor data of the sensor to be output to the information processing terminal 240. In the embodiment, the sensor data includes the manufacturing ID obtained by the bar code reader 920, data (hereinafter, also referred to as “line data”) of the light intensity reflected by the product 915 obtained by the line sensor 930, and data (hereinafter, also referred to as “temperature data”) of the temperature of the product 915 obtained by the temperature sensor 940. In a certain aspect, the data generation device 230 generates the packet data 400 including the image data of the product 915 photographed by the camera 220 and the SDP 440 storing the sensor data to be output to the information processing terminal 240.

On the basis of the data unit including the image data and the sensor data, the information processing terminal 240 executes an image processing program 950 including a welding inspection process 952 and a scratch/crack inspection process 954, and performs quality inspection for the product 915.

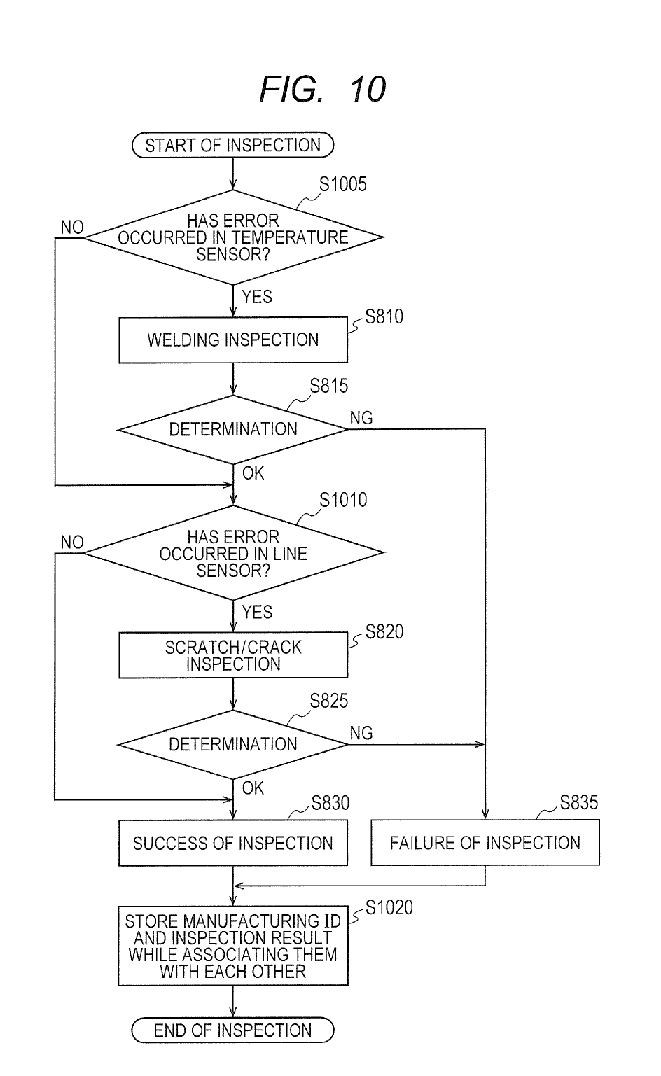

FIG. 10 is a flowchart for explaining the control of the quality inspection (image process) according to the embodiment. The process shown in FIG. 10 is realized by the CPU 344 executing the image processing program 950 stored in the ROM 348. In another aspect, a part or all of the process may be executed by circuit elements or other hardware. It should be noted that the parts followed by the same signs as those in FIG. 8 are substantially the same processes, and thus the explanation thereof will not be repeated in some cases.

In Step S1005, the CPU 344 determines whether or not the temperature indicated by the temperature data included in the data unit is within a proper range. In the case where the CPU 344 determines that the temperature of the welded part is within the proper range (YES in Step S1005), the CPU 344 advances the process to the scratch/crack inspection process of Step S1010. Otherwise (NO in Step S1005), the CPU 344 advances the process to the welding inspection of Step S810. Namely, in the case where the CPU 344 determines that the temperature of the welded part is within the proper range, the welding inspection is omitted. On the other hand, in the case where the CPU 344 determines that the temperature of the welded part is out of the proper range, the welding inspection is conducted because there is a possibility that a welding defect has occurred in the welded part. This is because the temperature of the welded part where a welding defect has occurred tends to be increased as compared to a usual case.

In Step S1010, the CPU 344 determines whether or not there is a possibility that scratches or cracks have occurred in the product 915 to be inspected on the basis of the line data included in the data unit. As an example, in the case where there is an area whose intensity is largely different from those of surrounding areas, the CPU 344 determines that there is a possibility that scratches or cracks have occurred in the product 915. In the case where the CPU 344 determines that there is a possibility that scratches or cracks have occurred in the product 915 to be inspected (YES in Step S1010), the process proceeds to Step S820. Otherwise (NO in Step S1010), the CPU 344 determines that the product 915 to be inspected is a non-defective product (Step S830).

In Step S1020, the CPU 344 associates the manufacturing ID included in the data unit with the inspection result to be stored in the storage device (for example, the ROM 348).

According to the above description, the image processing system 900 according to the embodiment omits the inspection by the image process for a defect that is unlikely to occur using the sensor data, and performs only the inspection by the image process for a possible defect. Therefore, the image processing system 900 can shorten the time required for the quality inspection and can reduce the load on the image process of the CPU 344 as compared to the quality inspection using only the image data according to related technique.

Further, the manufacturing ID is obtained on the basis of the image data in the quality inspection according to the related technique. However, the manufacturing ID cannot be obtained depending on an image photographed by the camera 220 in some cases (for example, a case in which the bar code is not accurately shown in the image). Namely, the system cannot associate the image data with the manufacturing ID in some cases.

On the other hand, the image processing system 900 according to the embodiment generates the data unit associating the information of the manufacturing ID obtained by the bar code reader 920 with the image data. Therefore, the system does not need the image process for obtaining the manufacturing ID, and can reliably associate the image data with the manufacturing ID. Further, the system can perform the above-described quality inspection at arbitrary timing after importing the inspection image by the camera 220 using the manufacturing ID.

It should be noted that the image processing system 900 is configured to obtain the manufacturing ID of the product 915 by reading the bar code (one-dimensional code) attached to the product 915 by the bar code reader 920 in the above-described example. However, the method of obtaining the manufacturing ID is not limited to this.

In another aspect, a QR code (two-dimensional code) (trademark registration) including the manufacturing ID, an RFID (Radio Frequency IDentifier) tag, and other symbols are attached to the product 915, and a sensor reading these may be coupled to the I/F board 210.

### Third Embodiment

In a third embodiment, a monitoring system using a monitoring camera in stores, airports, and the like will be described.

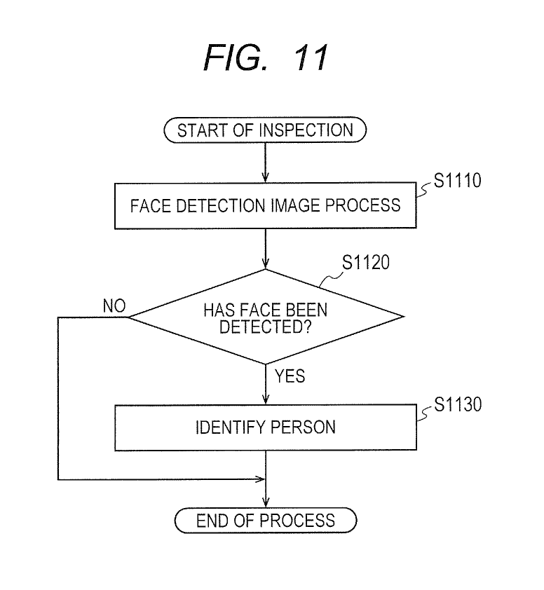

FIG. 11 is a flowchart for explaining an image process for monitoring according to the related technique. The process shown in FIG. 11 is realized by the processor executing the image processing program according to the related technique. In the example shown in FIG. 11, the image processing program according to the related technique detects a human from the image data obtained by the monitoring camera, and identifies the human.

In Step S1110, the processor executes an image process for detecting whether or not a human face is included in the image photographed by the camera. The image process for detecting a face can be realized by a known method (for example, face detection using a Haar-Like characteristic amount).

In Step S1120, the processor determines whether or not a human face is included in the image on the basis of the result of the image process in Step S1110. In the case where the processor determines that a human face is included in the image (YES in Step S1120), the process proceeds to Step S1130. Otherwise (NO in Step S1120), the processor finishes the series of processes.

In Step S1130, the processor calculates the characteristic amount of the face detected in Step S1120, and identifies the person by comparing the calculated characteristic amount with each of the characteristic amounts calculated in the past that are stored in the storage device. The calculation of the characteristic amount can be realized by a known method.

As described above, the image processing program for monitoring according to the related technique needs to execute the processes shown in Steps S1110 to S1130 for all the images photographed by the camera. More specifically, the program needs to execute the processes (Steps S1110 and S1120) for determining whether or not a person is present even for an image in which no person (face) exists. Therefore, the load on the image process for monitoring of the processor is increased. Hereinafter, the configuration and control of the image processing system according to the embodiment that can solve such a problem will be described.

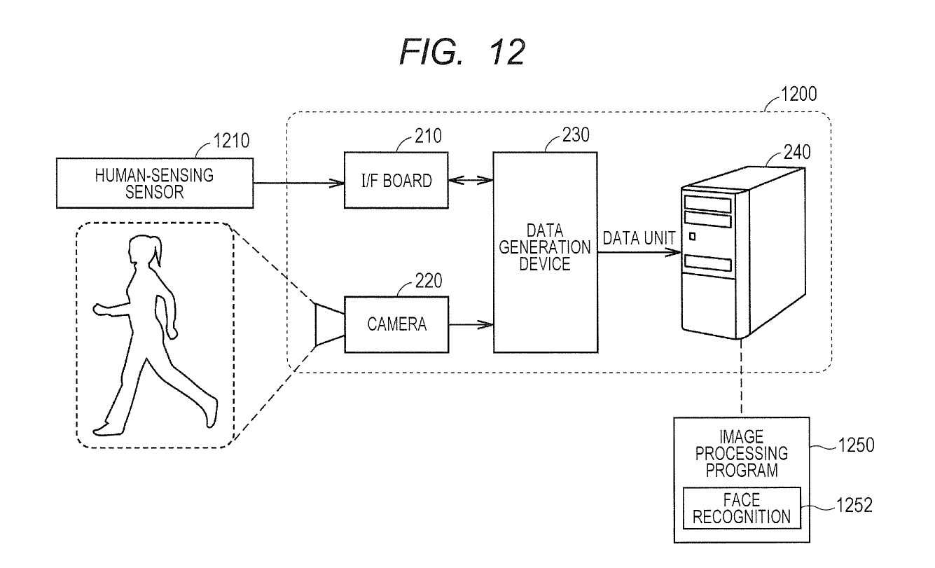

FIG. 12 is a diagram for explaining a configuration example of an image processing system 1200 according to the embodiment. The configuration of the imaging processing system 1200 is substantially the same as that of the above-described image processing system 200, and thus only the differences will be described.

The I/F board 210 is electrically coupled to a human-sensing sensor 1210. As an example, the human-sensing sensor 1210 is configured using a pyroelectric element. The human-sensing sensor 1210 detects whether or not a person exists in a viewing area photographed by the camera 220. The camera 220 is a monitoring camera, and photographs a person located in a shop or an airport. The data generation device 230 generates the data unit including the image data obtained by the camera 220 and sensor data (hereinafter, also referred to as “human-sensing data”) indicating whether or not a person is present in the vicinity obtained by the human-sensing sensor 1210. The data generation device 230 outputs the generated data unit to the information processing terminal 240. The information processing terminal 240 executes an image processing program 1250 including a face recognition process 1252 on the basis of the input data unit. In a certain aspect, the data generation device 230 generates the packet data 400 including the image data obtained by the camera 220 and the SDP 440 storing the human-sensing data to be output to the information processing terminal 240.

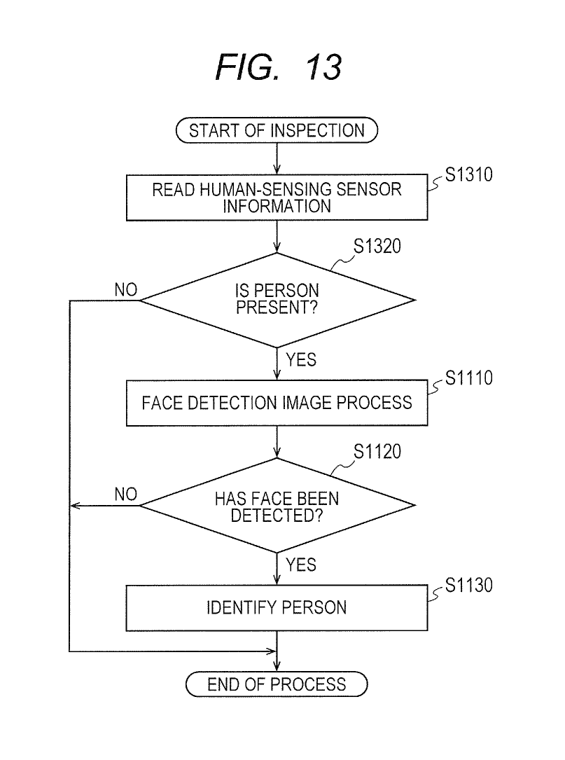

FIG. 13 is a flowchart for explaining the control of the image process according to the embodiment. The process shown in FIG. 13 is realized by the CPU 344 executing the image processing program 1250 stored in the ROM 348. In another aspect, a part or all of the process may be executed by circuit elements or other hardware. It should be noted that the parts followed by the same signs as those in FIG. 11 are the same processes, and thus the explanation thereof will not be repeated in some cases.

In Step S1310, the CPU 344 reads the human-sensing data included in the data unit. In Step S1320, the CPU 344 determines whether or not the human-sensing sensor 1210 detects a person on the basis of the human-sensing data. In the case where the CPU 344 determines that the human-sensing sensor 1210 detects a person (YES in Step S1320), the process proceeds to Step S1110. Otherwise (NO in Step S1320), the CPU 344 finishes the process without executing the image process of face recognition.

According to the above description, the image processing system 1200 according to the embodiment executes a series of image processes of face recognition only in the case where it is determined that a person is present in the viewing area photographed by the camera 220 on the basis of the human-sensing data included in the data unit. Therefore, the image processing system 1200 according to the embodiment can shorten the time required for the image process and can reduce the load on the image process of the CPU 344 as compared to the system using only the image data according to the related technique.

### Fourth Embodiment

In the above-described embodiments, the data generation device 230 generates the data unit including the image data and the sensor data synchronized with the timing at which the image data is obtained (photographed) on the basis of the vertical synchronous signal output from the synchronous signal output circuit 324 of the camera 220. However, some cameras do not output the vertical synchronous signal to the outside. Accordingly, a configuration and control for generating a data unit including image data and sensor data synchronized with the timing at which the image data is photographed even in the case where such a camera is used will be described.

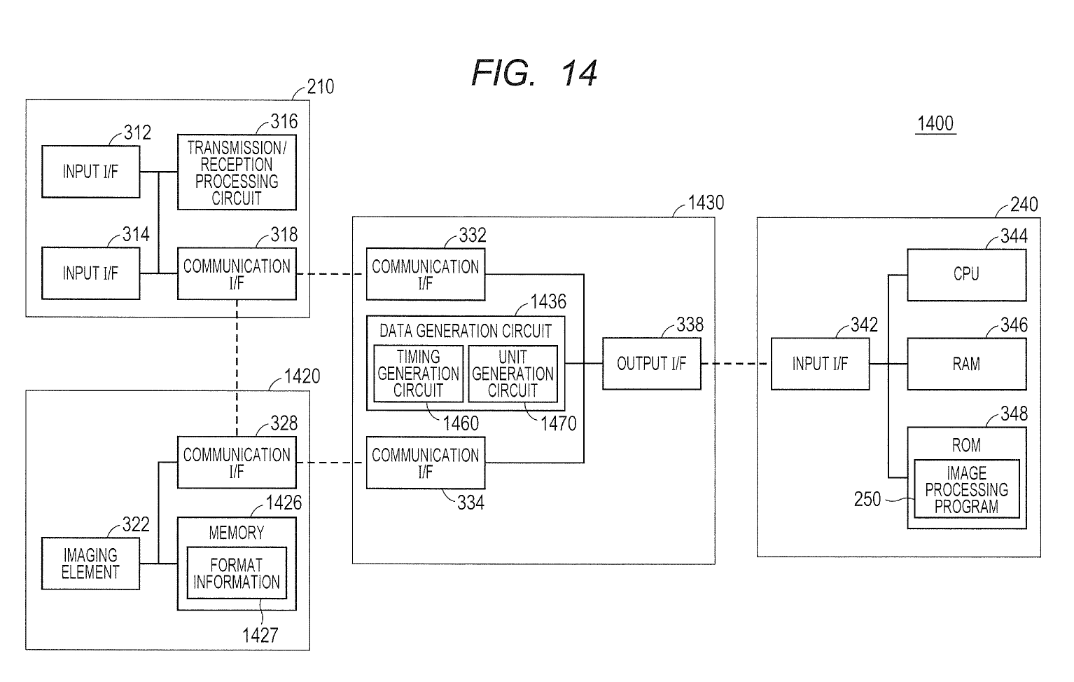

FIG. 14 is a diagram for explaining a configuration example of an image processing system 1400 according to an embodiment. It should be noted that the parts followed by the same signs as those in FIG. 3 are the same, and thus the explanation thereof will not be repeated.

With reference to FIG. 14, the image processing system 1400 is different from the image processing system 200 in that the camera 220 and the data generation device 230 are replaced by a camera 1420 and a data generation device 1430, respectively. The cameras 1420 has no synchronous signal output circuit 324. The camera 1420 has a memory 1426 instead of the memory 326. Format information 1427 is stored in the memory 1426 in a nonvolatile manner. The format information 1427 includes information of the number of images (frame rate) photographed by the camera 1420 in one second. In addition to the frame rate information, the format information 1427 may include information such as the vertical blanking period, the horizontal blanking period, the number of vertical effective pixels, the number of horizontal effective pixels, and the RGB color depth (RGB data amount per pixel) of the camera 1420.

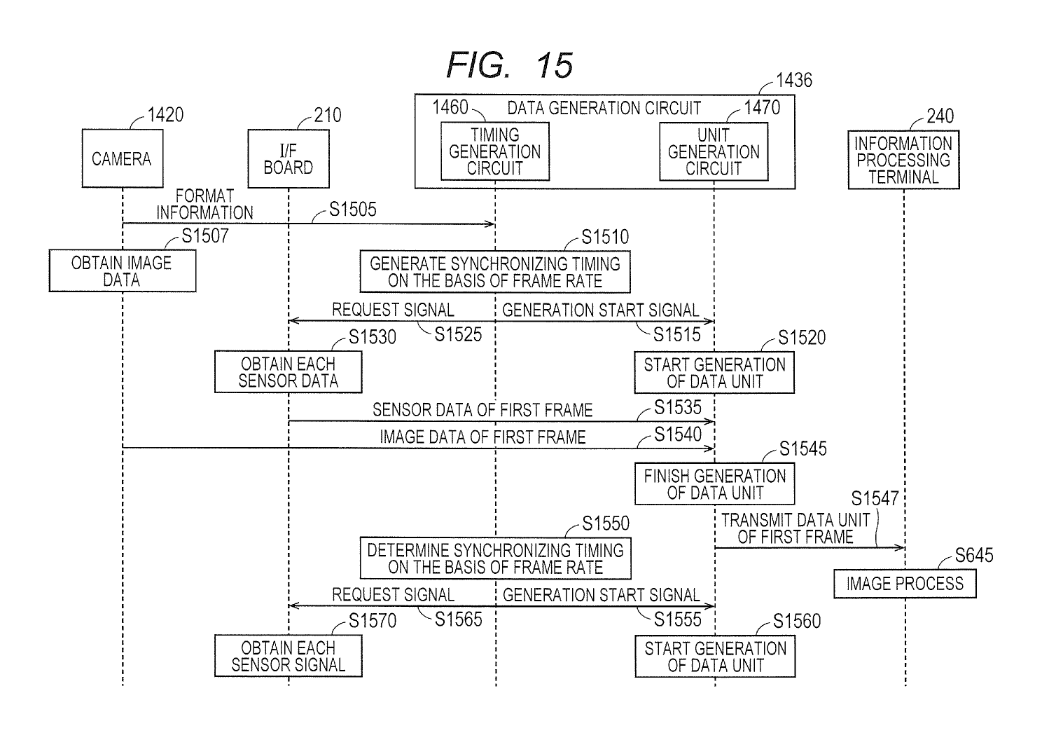

The data generation device 1430 has a data generation circuit 1436 instead of the data generation circuit 336. The data generation circuit 1436 includes a timing generation circuit 1460 and a unit generation circuit 1470. Next, the functions of the timing generation circuit 1460 and the unit generation circuit 1470 will be described using FIG. 15.

FIG. 15 is a flowchart for explaining a method of generating the data unit according to the embodiment.

In Step S1505, the timing generation circuit 1460 obtains the format information 1427 from the camera 1420. In Step S1507, the camera 1420 obtains the image data to be temporarily stored in the memory 1426. In Step S1510, the timing generation circuit 1460 generates synchronizing timing on the basis of the frame rate information included in the format information 1427. As an example, in the case where the frame rate is 60 Hz, the timing generation circuit 1460 generates a synchronizing timing of 60 Hz.

In Step S1515, the timing generation circuit 1460 outputs a generation start signal to the unit generation circuit 1470 at timing according to the generated synchronizing timing. In Step S1520, the unit generation circuit 1470 starts generating the unit data in response to the reception of the generation start signal.

In Step S1525, the timing generation circuit 1460 outputs a request signal to the I/F board 210 at timing according to the generated synchronizing timing. In Step S1530, the I/F board 210 obtains the sensor data (for example, the brightness data and proximity data) of the first frame in response to the reception of the request signal from the data generation device 1430. In Step S1535, the I/F board 210 outputs the obtained sensor data of the first frame to the unit generation circuit 1470. The unit generation circuit 1470 temporarily stores the received sensor data of the first frame into the memory 335.

In Step S1540, the unit generation circuit 1470 accesses the memory 1426 of the camera 1420 via the communication I/Fs 334 and 328 to obtain the image data of the first frame. The unit generation circuit 1470 temporarily stores the image data into the memory 335.

In Step S1545, the unit generation circuit 1470 generates the data unit including the image data of the first frame and the sensor data of the first frame stored in the memory 335, and finishes the process of generating the data unit.

In Step S1547, the unit generation circuit 1470 outputs the generated data unit to the information processing terminal 240 via the output I/F 338. In Step S645, the CPU 344 of the information processing terminal 240 executes a series of image processes according to the image processing program 250 for the data unit of the first frame.

In Step S1550, the timing generation circuit 1460 generates the synchronizing timing of the second frame on the basis of the frame rate information and the synchronizing timing generated last time (Step S1510). As an example, in the case where the frame rate is 60 Hz, the timing generation circuit 1460 generates synchronizing timing after 1/60 second from the synchronizing timing generated last time. The image processing system 1400 repeatedly executes the processes of the Steps S1510 to S1547 and the Step S645 after the second frame.

According to the above description, the data generation device 1430 according to the embodiment can generate the data unit by associating the image data with the sensor data output from each sensor on the basis of the format information. Accordingly, even in the case where the camera is not configured to output the vertical synchronous signal to the outside, the data unit including the image data obtained by the camera and the sensor data synchronized with the timing at which the image data is obtained (photographed) can be generated. In general, an expensive camera has a configuration (synchronous signal output circuit) that outputs the vertical synchronous signal to the outside, but an inexpensive camera does not have the configuration. Even if the image processing system 1400 according to the fourth embodiment is configured to use an inexpensive camera, it is possible to generate the data unit including the image data and the sensor data. Namely, even if the image processing system 1400 according to the fourth embodiment is configured to use an inexpensive camera, it is possible to shorten the image process time and reduce the load on the image process by properly determining the content of the image process on the basis of the sensor data.

In a certain aspect, the data generation circuit 336 generates packet data compliant with the known DisplayPort as an example of the data unit. Accordingly, the input I/F 342 of the information processing terminal 240 can also employ a connector compliant with the existing DisplayPort. It should be noted that the data generation circuit 336 may have a configuration compliant with other specifications in which packets can be generated in another aspect. More preferably, the data generation circuit 336 is preferably compliant with specifications in which packet data including the image data and the sensor data can be generated and the generated packet data can be output at timing (namely, including the timing according to the vertical synchronous signal) according to the frame rate of the camera 220. Accordingly, the information processing terminal 240 can execute real-time image processes (for example, the processes described in the first and third embodiments) for moving image data.

The processes described in the above embodiments can be executed in such a manner that a circuit having an operational function reads one or more commands from, at least, one tangible readable medium.

Such a medium takes a form such as a magnetic medium (for example, a hard disk), an optical medium (for example, a compact disc (CD) or a DVD), a volatile memory, or an arbitrary type of nonvolatile memory. However, the present invention is not limited thereto.

The volatile memory can include a DRAM (Dynamic Random Access Memory) and an SRAM (Static Random Access Memory). The nonvolatile memory can include a ROM and a NVRAM.

The invention achieved by the inventors has been concretely described above on the basis of the embodiments. However, it is obvious that the present invention is not limited to the above-described embodiments, and can be variously changed without departing from the gist thereof.

What is claimed is:

1. A data generation device that is configured to be able to communicate with an external device performing an image process, the device comprising:
a first communication interface that receives image data obtained by a camera;
a second communication interface that receives sensor data output from a sensor; and
a data generation unit that generates a data unit including the image data received via the first communication interface and the sensor data received via the second communication interface and transmits the generated data unit to the external device,
wherein the external device is configured to determine the content of the image process for the image data associated with the sensor data on the basis of the sensor data included in the data unit, and
wherein the data generation unit generates the data unit including the image data and the sensor data output from the sensor on the basis of information for synchronization received from the camera via the first communication interface.

2. The data generation device according to claim 1,
wherein the information for synchronization includes information of the frame rate of the camera.

3. The data generation device according to claim 2,
wherein the data generation unit obtains the sensor data output from the sensor and the image data from the camera at timing according to the frame rate, and generates the data unit including the obtained sensor data and image data.

4. The data generation device according to claim 1,
wherein the information for synchronization includes a vertical synchronous signal of the camera.

5. The data generation device according to claim 4,
wherein the data generation unit obtains the sensor data output from the sensor and the image data from the camera in response to the reception of the vertical synchronous signal, and generates the data unit including the obtained sensor data and image data.

6. The data generation device according to claim 5,
wherein the sensor is configured to be able to receive the vertical synchronous signal from the camera, and
wherein the data generation unit generates a data generation device data unit including the image data obtained from the camera in response to the reception of the vertical synchronous signal and the sensor data output from the sensor in response to the reception of the vertical synchronous signal.

7. The data generation device according to claim 1,
wherein the data generation unit generates packet data compliant with DisplayPort as the data unit, and stores the sensor data into an SDP (Secondary Data Packet).

8. An image processing system comprising:
a camera;
a sensor;
a data generation device that generates a data unit; and
an image processing device that performs an image process on the basis of the data unit,
wherein the data generation device includes:
a first communication interface that receives image data obtained by the camera;
a second communication interface that receives sensor data output from the sensor; and
a data generation unit that generates the data unit including the image data received via the first communication interface and the sensor data received via the second communication interface, and transmits the generated data unit to the image processing device,
wherein the data generation unit generates the data unit including the image data and the sensor data obtained by the sensor on the basis of information for synchronization received from the camera via the first communication interface, and
wherein the image processing device determines the content of the image process for the image data associated with the sensor data on the basis of the sensor data included in the data unit.

9. A method of generating a data unit for an image process to be transmitted to an external device, the external device being configured to determine the content of the image process for image data associated with sensor data on the basis of the sensor data included in the data unit, the method comprising the steps of:
receiving the image data obtained by a camera;
receiving the sensor data output from a sensor;
receiving information for synchronization from the camera, and
generating the data unit including the image data and the sensor data output from the sensor on the basis of the information for synchronization.
